(19) United States
(12) Patent Application Publication
(10) Pub. No.: US 2026/0110191 A1
(43) Pub. Date: Apr. 23, 2026

(54) HANDLE DEVICE

(71) Applicant: PIOLAX CORPORATION, Canton, GA (US)

(72) Inventor: Hisashi NAKASONE, Kanagawa (JP)

(73) Assignee: PIOLAX CORPORATION, Canton, GA (US)

(21) Appl. No.: 19/358,131

(22) Filed: Oct. 14, 2025

(30) Foreign Application Priority Data
Oct. 18, 2024 (JP) 2024-182544

(51) Int. Cl. E05B 7/00; E05B 15/04

(52) U.S. Cl. CPC E05B 7/00; E05B 15/04

(57) ABSTRACT

A handle device includes: a fixing member including a cylinder part having one end open and another end at a bottom portion; a handle rotatably provided on the fixing member and configured to become an open state or a closed state by rotation; a biasing member configured to bias the handle in a closing direction; and a piston inserted into the cylinder part so as to be advanceable and retractable. The piston includes a sliding part provided on an outer peripheral surface thereof. The piston is pushed and retracts toward the bottom portion when the handle is rotated in the closing direction, causing the sliding part to be slid along an inner peripheral surface of the cylinder part in response to the retraction, thereby providing resistance against a closing operation of the handle.

### CROSS-REFERENCE TO RELATED APPLICATIONS

This application is based on and claims priority under 35 USC §119 from Japanese Patent Application No. 2024-182544 filed on October 18, 2024, the contents of which are incorporated herein by reference.

### TECHNICAL FIELD

The present disclosure relates to a handle device that includes a piston between a handle and a fixing member.

### BACKGROUND

WO2020/080343A1 (PTL 1) discloses a locking device for an opening and closing body that is openably and closably attached to an opening of a fixed body. The locking device includes a locking member provided in the opening of the fixed body, an operating member that slides the locking member, a base member that rotatably supports the operating member, and a rubber damper mounted on the base member.

Although a damper is provided as a measure against impact noise during a rotation of the operating member described in PTL 1, it is desirable to achieve a more effective reduction of the impact noise.

An object of the present disclosure is to provide a handle device capable of effectively reducing the impact noise generated when the handle is closed.

### SUMMARY

A handle device according to an aspect of the present disclosure includes a fixing member including a cylinder part having one end open and another end at a bottom portion; a handle rotatably provided on the fixing member and configured to become an open state or a closed state by rotation; a biasing member configured to bias the handle in a closing direction; and a piston inserted into the cylinder part and provided so as to be advanceable and retractable. The piston includes a sliding part provided on an outer peripheral surface thereof. The piston is pushed and retracts toward a bottom portion when the handle is rotated in the closing direction, causing the sliding part to slide along an inner peripheral surface of the cylinder part in response to the retraction, thereby providing resistance against a closing operation of the handle.

### BRIEF DESCRIPTION OF DRAWINGS

FIG. 1 is a perspective view of a handle device in a closed state according to an embodiment.

FIG. 2 is a perspective view of the handle device in an open state according to an embodiment.

FIG. 3 is an exploded diagram of the handle device according to an embodiment.

FIG. 4 is a cross-sectional view of the handle device shown in FIG. 1 taken along the line A-A.

FIG. 5A is a front view of a piston, and FIG. 5B is a cross-sectional view of the piston.

FIG. 6 is a cross-sectional view of the handle device shown in FIG. 1 taken along the line B-B.

FIG. 7 is a partial enlarged view of the handle device shown in FIG. 6.

FIG. 8 is a cross-sectional view of the handle device in a fully open state.

FIG. 9 is a diagram illustrating a piston according to a first modification.

FIG. 10 is a diagram illustrating a piston according to a second modification.

FIG. 11 is a perspective view of a fixing member according to a third modification.

FIG. 12 is a cross-sectional view of a handle device according to the third modification.

### DESCRIPTION OF EMBODIMENTS

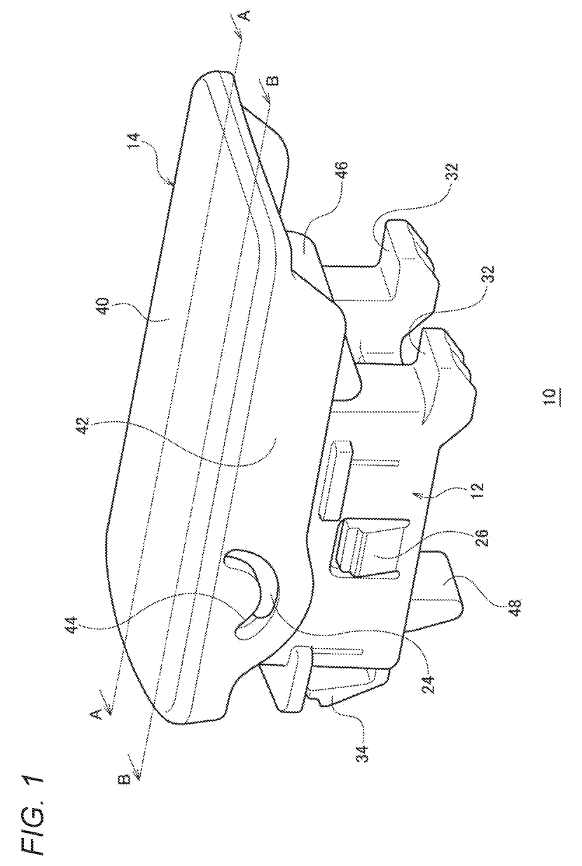

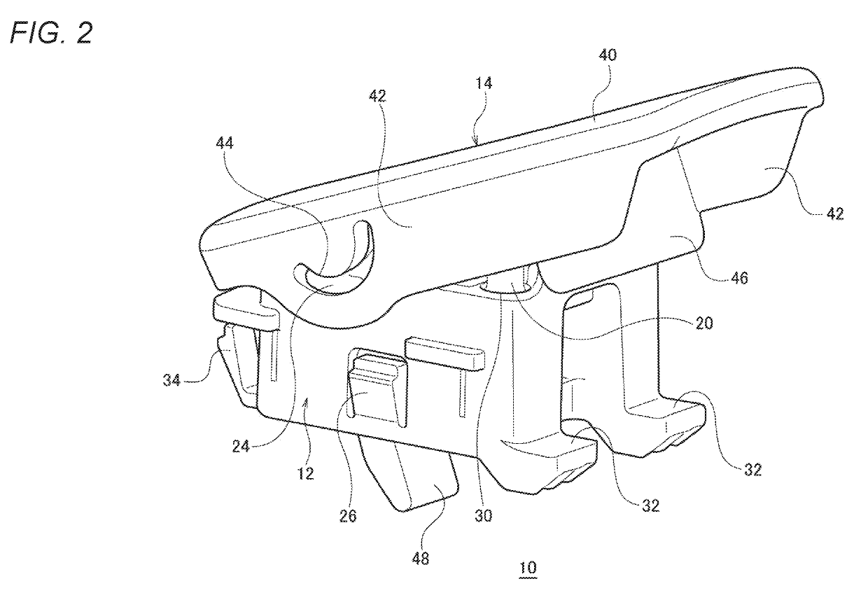

FIG. 1 is a perspective view of a handle device 10 in a closed state according to an embodiment. FIG. 2 is a perspective view of the handle device 10 in an open state according to an embodiment. The handle device 10 is attached to an opening and closing body and is used for an operation of opening and closing the opening and closing body.

The opening and closing body is provided to open and close an opening of a fixed body, such as a glove box provided in a vehicle, and functions as a lid. A locking member interlocked with the operation of the handle device 10 is supported on the opening and closing body. The locking member is locked in a state in which the opening and closing body closes the opening of the fixed body. When the user operates the handle device 10, the lock of the locking member may be released to open the opening and closing body. That is, the handle device 10 also functions as a locking device. A mounting hole for mounting the handle device 10 is formed in the opening and closing body.

The handle device 10 is not limited to being attached to the opening and closing body of the glove box, but may instead be attached, for example, to the opening and closing body of a console box. The handle device 10 may be provided on the fixed body and may be held by the user. The fixed body is not limited to the glove box, but may be an interior panel or a vehicle body panel.

A handle 14 of the handle device 10 shown in FIG. 1 is in a closed state with respect to a fixing member 12. The handle 14 shown in FIG. 2 is in an open state with respect to the fixing member 12. The handle device 10 will be described with reference to another figure.

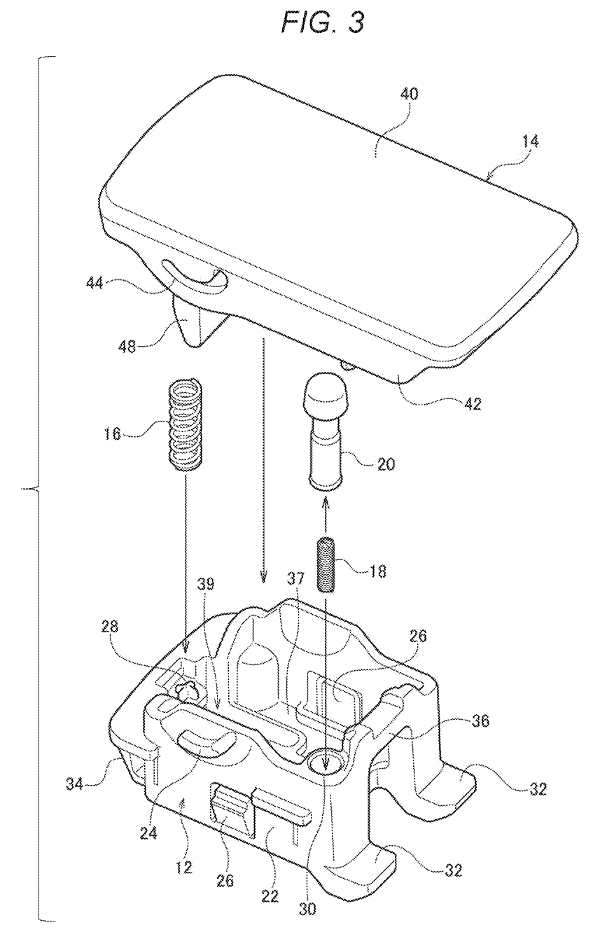

FIG. 3 is an exploded diagram of the handle device 10. The handle device 10 includes the fixing member 12, the handle 14, a biasing member 16, a spring 18, a piston 20, and a locking member (not shown). The fixing member 12 is fixed to the opening and closing body or the fixed body. The handle 14 is rotatably provided on the fixing member 12 and becomes an opened state or a closed state by rotation.

The biasing member 16 contacts the fixing member 12 and the handle 14, respectively, and biases the handle 14 in a closing direction. The biasing member 16 is a coil spring, but not limited thereto, and may be a plate spring.

The piston 20 is provided between the fixing member 12 and the handle 14 to suppress the impact noise caused by the handle 14 hitting the fixing member 12 upon closing. The spring 18 biases the piston 20 toward the handle 14. The moment applied to the handle 14 by the spring 18 through the piston 20 is much smaller than the moment applied to the handle 14 by the biasing member 16.

The fixing member 12 includes a sidewall part 22, a shaft support 24, an elastic claw part 26, a first support protrusion 28, a cylinder part 30, a first mounting part 32, a second mounting part 34, a suspension part 36, a bottom portion 37, a stopper part, and an insertion hole 39.

A pair of sidewall parts 22 are formed so as to face each other. The shaft support 24 protrudes from an outer surface of the sidewall part 22 and is formed in an arc shape. The shaft support 24 axially supports the handle 14. The elastic claw part 26 is formed flexibly on the sidewall part 22. The first support protrusion 28 protrudes upward and supports one end of the biasing member 16.

The first mounting part 32 protrudes forward of the fixing member 12. The second mounting part 34 is formed on a rear portion of the fixing member 12 and is formed in a claw shape having elasticity. The elastic claw part 26, the first mounting part 32, and the second mounting part 34 each engage with the opening and closing body. The suspension part 36 is positioned at an upper end of a front portion of the fixing member 12.

The cylinder part 30 accommodates the spring 18 and the piston 20. The cylinder part 30 is open toward the handle 14 side. The insertion hole 39 is formed through the bottom portion 37 so that a part of the handle 14 may be inserted therein.

The handle 14 includes a design surface 40, a sidewall part 42, a bearing part 44, a protective wall part 46, a transmission part 48, a back surface, and a second support protrusion. The design surface 40 is formed at a position exposed from the mounting hole of the opening and closing body and is positioned on the front side of the handle device 10.

A pair of sidewall parts 42 are formed so as to face each other. The bearing part 44 is formed as a hole in the sidewall part 42 and is formed in an arc shape. The bearing part 44 receives the shaft support 24 of the fixing member 12. The protective wall part 46 is formed so as to span the pair of sidewall parts 42 so as to be orthogonal to the back surface of the handle 14. The protective wall part 46 prevents a user's finger from entering inside the handle device 10.

The transmission part 48 is formed in a columnar shape, extends from the back surface in a direction orthogonal to the back surface, is inserted into the insertion hole 39 of the fixing member 12, and protrudes into the back side of the fixing member 12 as shown in FIG. 2. The transmission part 48 is displaced on the back side of the fixing member 12 as the handle 14 is rotated.

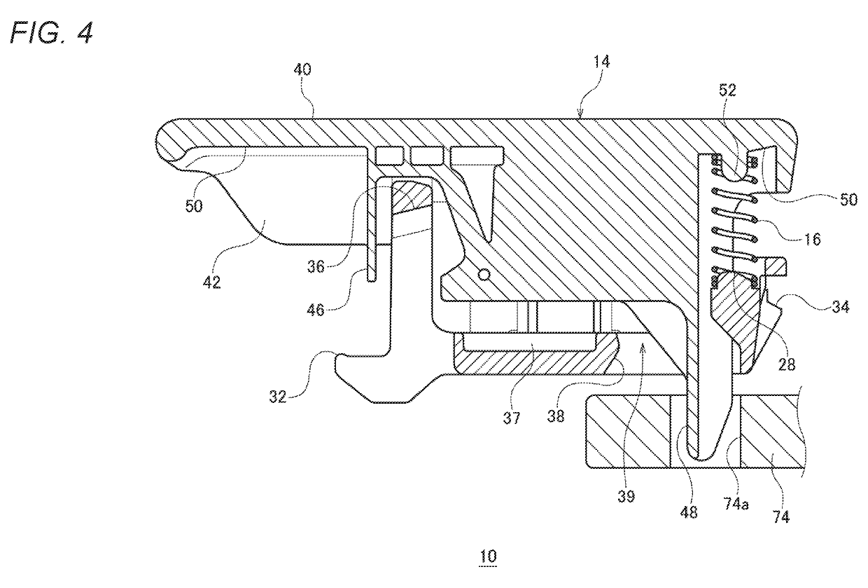

FIG. 4 is a cross-sectional view of the handle device 10 shown in FIG. 1 taken along the line A-A. The biasing member 16 has one end supported by the first support protrusion 28 of the fixing member 12, and another end supported by a second support protrusion 52 of the handle 14. The second support protrusion 52 is formed on a back surface 50. The biasing member 16 biases the handle 14 in the closing direction against the spring 18.

The transmission part 48 is inserted into the insertion hole 39 of the fixing member 12. The stopper part 38 is formed on an edge of the bottom portion 37 that forms the insertion hole 39. The stopper part 38 contacts on the transmission part 48 to stop the rotation of the handle 14 in the opening direction. The piston 20 acts on the rotation of the handle 14 in the closing direction.

The transmission part 48 is inserted into an insertion hole 74a of a locking member 74. The transmission part 48 transfers a stroke to the locking member 74 in response to the rotating operation of the handle 14, causing the locking member 74 to be moved from a locked position to an unlocked position. With the handle 14 shown in FIG. 4 in the closed state, the locking member 74 is in the locked position. With the handle 14 in fully open state, the locking member 74 is in the unlocked position. The locking member 74 is provided on the opening and closing body and locked to the fixed body, but aspects are not limited thereto, and the locking member 74 may be provided on the fixed body and locked to the opening and closing body.

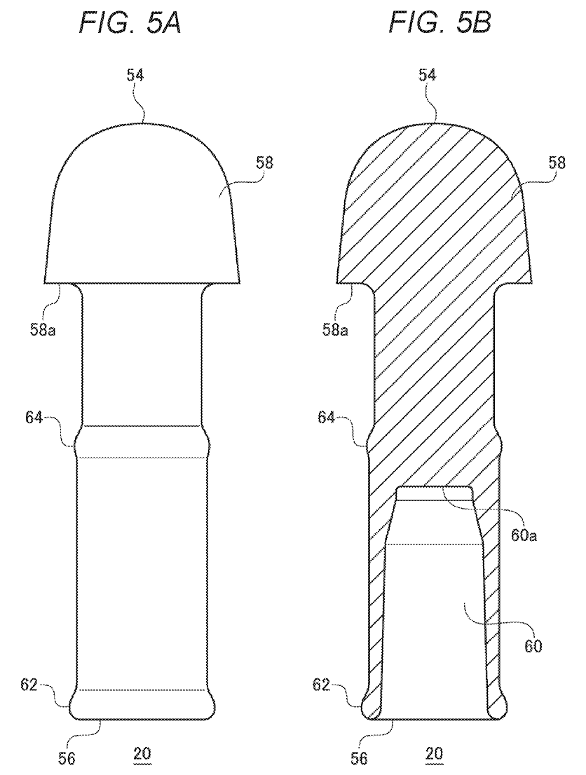

FIG. 5A is a front view of the piston 20, and FIG. 5B is a cross-sectional view of the piston 20. The piston 20 is formed of a soft resin material. The piston 20 includes a contact part 54, an opening 56, a cushion part 58, an extension part 60 and a sliding part 62.

The contact part 54 is positioned at one end of the piston 20 so as to be able to contact the back surface 50 of the handle 14. The opening 56 is positioned and open at another end of the piston 20. The cushion part 58 is formed and bulges from one end side of the piston 20. An end portion of the cushion part 58 is the contact part 54. The cushion part 58 includes a step portion 58a protruding outward in a radial direction.

The extension part 60 is formed in a cylindrical shape and is open in another end. One end side of the extension part 60 forms a bottom surface 60a. The extension part 60 forms a space that accommodates the spring 18. The spring 18 is positioned inside the extension part 60, with one end in contact with the bottom surface 60a.

The sliding part 62 is formed on an outer peripheral surface of the extension part 60 and formed in an annular shape protruding outward in the radial direction. The sliding part 62 is positioned at the other end of the piston 20 and positioned at the opening end side of the extension part 60. The sliding part 62 is slid within the cylinder part 30 of the fixing member 12.

A rib 64 is formed so as to protrude from an outer peripheral surface of the piston 20. The rib 64 is formed at an intermediate portion of the piston 20 away from the sliding part 62. When the handle 14 is rotated in the closing direction, the piston 20 is subjected to a force in a direction crossing a central axis of the cylinder part 30 from the handle 14, but the rib 64 prevents tilting of the piston 20 and functions as a guide during the advance and retraction of the piston 20. The rib 64 is formed in a smaller diameter than an inner diameter of the cylinder part 30. The rib 64 is positioned on the contact part 54 side with respect to the bottom surface 60a.

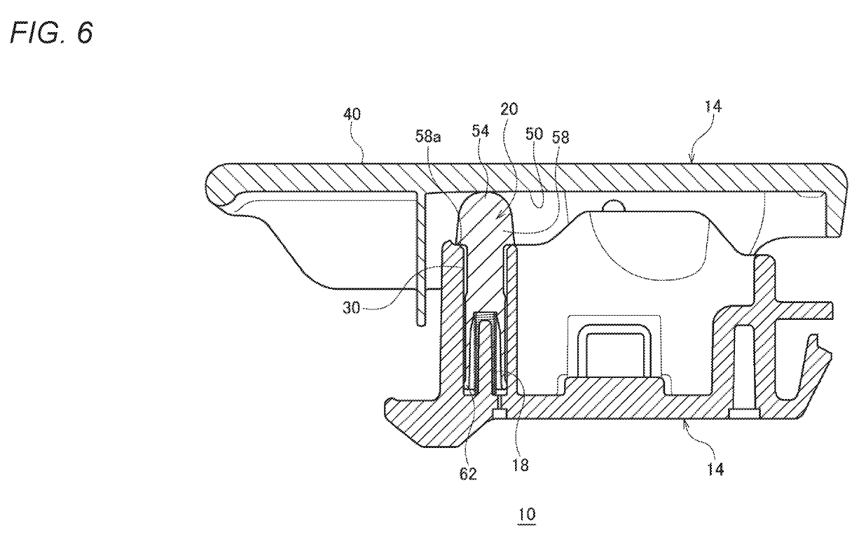

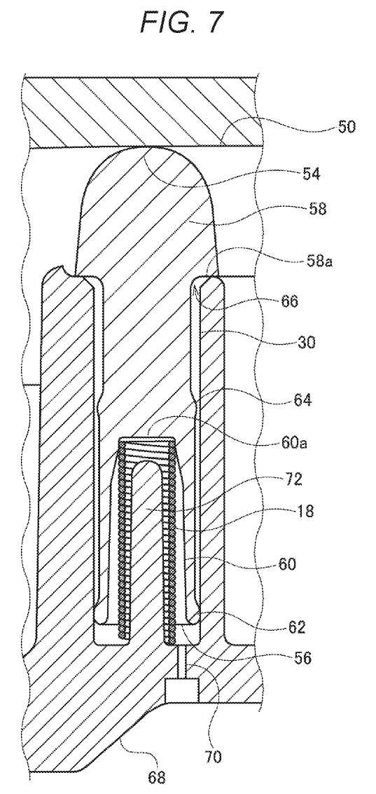

FIG. 6 is a cross-sectional view of the handle device 10 shown in FIG. 1 taken along the line B-B. Further, FIG. 7 is a partial enlarged view of the handle device 10 illustrated in FIG. 6. The cylinder part 30 includes an opening 66, a bottom portion 68, an orifice part 70 and a column part 72. The cylinder part 30, the spring 18 and the piston 20 are coaxially disposed. The cylinder part 30 is positioned on the opposite side of the biasing member 16 with a rotational axis of the handle 14 interposed therebetween.

The opening 66 is positioned at one end of the cylinder part 30, and the bottom portion 68 is positioned at another end of the cylinder part 30. The orifice part 70 is formed in the bottom portion 68 and communicates between the inside and outside of the cylinder part 30. The column part 72 is erected from the bottom portion 68. The column part 72 is inserted into the spring 18 to support the spring 18.

The piston 20 is inserted into the cylinder part 30 so as to be advanceable and retractable. An outer diameter of the sliding part 62 is greater than an inner diameter of the cylinder part 30. Accordingly, the sliding part 62 comes into contact with and seals against the entire circumference of an inner peripheral surface of the cylinder part 30. As a result, the sliding part 62 is slid along the inner peripheral surface of the cylinder part 30 in response to the advance and retraction of the piston 20, exerting resistance.

The extension part 60 opens toward the bottom portion 68 of the cylinder part 30. Without considering the orifice part 70, the piston 20 and the cylinder part 30 form a closed space. The pressure in the space changes in response to the advance and retraction of the piston 20, functioning as a damper.

The spring 18, accommodated in the cylinder part 30, is positioned inside the extension part 60. The spring 18 has one end in contact with the bottom portion 68 and another end in contact with the bottom surface 60a of the piston 20, and biases the piston 20 in the advancing direction out of the cylinder part 30. As a result, the advance of the piston 20 does not cause resistance against the handle 14, and the piston 20 can follow the handle 14 that is rotated in the opening direction. By disposing the spring 18 inside the extension part 60, the piston 20 and the spring 18 can be configured to be shortened in the axial direction. The sliding part 62 is formed at the extension part 60 and is positioned on the opening 56 side of the extension part 60. By forming the piston 20 longer with the extension part 60, when the handle 14 is open and the piston 20 protrudes significantly from the cylinder part 30, the extension part 60 remains inside the cylinder part 30, making the piston 20 less likely to tilt. Since the sliding part 62 is press-contact with the cylinder part 30 at the position of the opening end of the extension part 60, the posture of the piston 20 can be easily maintained.

When the piston 20 retracts, the step portion 58a contacts the edge of the opening 66 of the cylinder part 30, stopping the retraction and thereby stopping the closing operation of the handle 14. As a result, direct contact with the fixing member 12 during closing of the handle 14 is prevented, and the cushion part 58 can absorb the impact when the handle 14 is closed.

A central axial direction of the cylinder part 30 intersects the design surface 40 and is substantially orthogonal to the design surface 40 in the closed state. Since the piston 20 contacts the back surface 50, a configuration for preventing the impact of closing the handle 14 by the piston 20 and the cylinder part 30 may be disposed on the back side of the design surface 40 so as not to be exposed, allowing the handle device 10 to be made smaller.

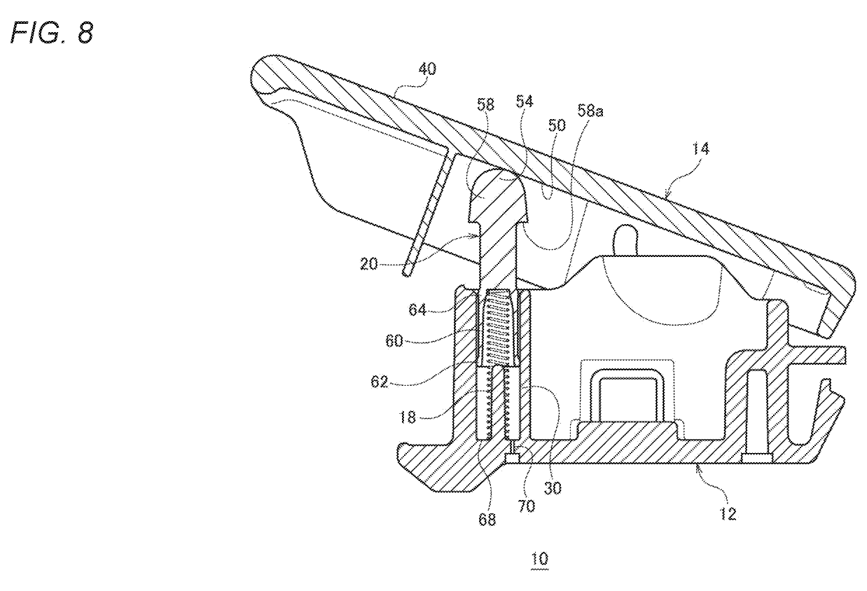

FIG. 8 is a cross-sectional view of the handle device 10 in a fully open state. When the handle 14 is in a fully open state, the piston 20 is biased by the spring 18 to remain in contact with the back surface 50. When the user releases the finger from the handle 14, the handle 14 is rotated in the closing direction by the biasing member 16.

The piston 20 is pushed and retracts toward the bottom portion 68 when the handle 14 is rotated in the closing direction, and in response to the retraction, causing the sliding part 62 to be slid along the inner peripheral surface of the cylinder part 30, thereby providing resistance against the closing operation of the handle 14. As a result, the impact noise when the handle 14 is closed can be reduced.

The space of the cylinder part 30 sealed by the sliding part 62 is compressed by the retraction of the piston 20, providing resistance against the closing operation of the handle 14. As a result, the impact noise when the handle 14 strikes the fixing member 12 side can be greatly reduced due to the friction force of the sliding part 62 and the compressed air pressure. The compressed air in the cylinder part 30 is gradually discharged by the orifice part 70.

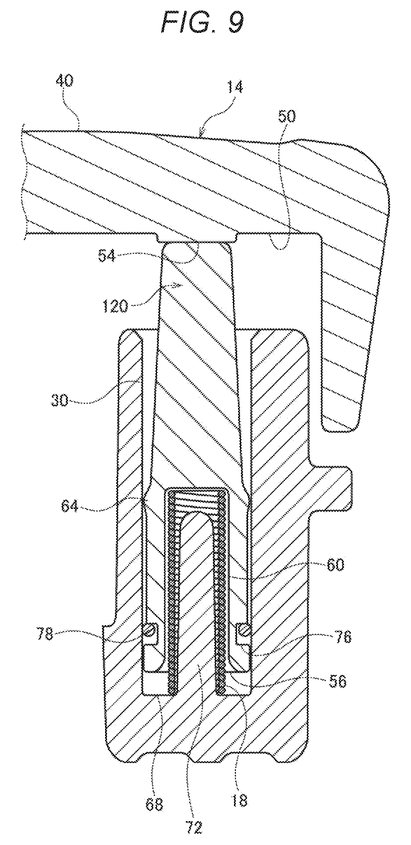

FIG. 9 is a diagram illustrating a piston 120 according to a first modification. The piston 120 has a different shape compared to the piston 20 shown in FIG. 7. The piston 120 includes the contact part 54, the opening 56, the extension part 60, the rib 64, and a groove part 76. The groove part 76 is formed in an annular shape on an outer peripheral surface of the extension part 60.

A sliding part 78 is formed of a rubber material in an annular shape and is held by the groove part 76. The sliding part 78 comes into contact with and seals against the entire circumference of the inner peripheral surface of the cylinder part 30. When the piston 120 retracts, the sliding part 78 slides along the inner peripheral surface of the cylinder part 30 in response to the retraction, thereby providing resistance against the closing operation of the handle 14. The space of the cylinder part 30 sealed by the sliding part 78 is compressed by retraction of the piston 120, providing resistance against the closing operation of the handle 14.

A width of the groove part 76 along the central axial direction of the piston 120 is greater than a diameter of the sliding part 78, and the sliding part 78 is movable in the groove part 76 in the axial direction. Accordingly, when the sliding part 78 does not contact an inner wall of the groove part 76, the groove part 76 functions as an orifice part to communicate between the inside and outside of the cylinder part 30.

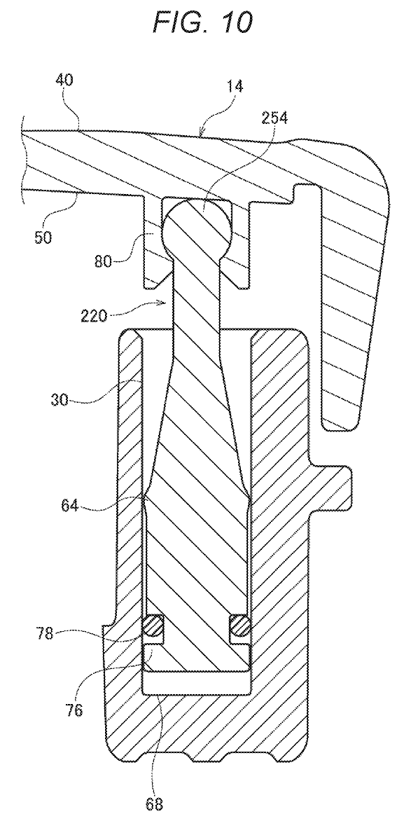

FIG. 10 is a diagram illustrating a piston 220 according to a second modification. Unlike the piston 120 shown in FIG. 9, the piston 220 is not biased by the spring 18, but is instead configured to be connected to the handle 14 to follow the movement of the handle 14.

The piston 220 includes a connection part 254, the rib 64, and the groove part 76. The connection part 254 is provided on one end side of the piston 220 and the groove part 76 is provided on another end side of the piston 220. The connection part 254 is formed in a flange shape protruding outward in the radial direction and is always connected to the handle 14.

The handle 14 includes a fitting part 80 formed on the back surface 50. The fitting part 80 includes a claw protruding inward in the radial direction. The fitting part 80 may include a pair of opposing elastic claws. The fitting part 80 is hooked onto and fitted with the connection part 254. Since the piston 220 is always connected to the handle 14, a spring for biasing the piston 220 is not required.

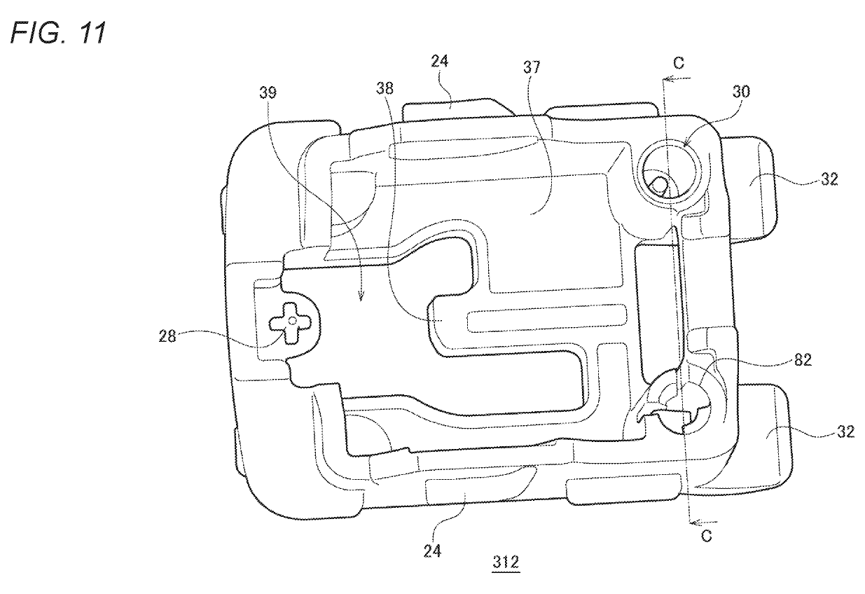

FIG. 11 is a perspective view of a fixing member 312 according to a third modification. The fixing member 312 differs from the fixing member 12 shown in FIG. 3 in that the position of the cylinder part 30 is different and that a holding portion 82 is provided. The holding portion 82 may hold a cushion member. The cylinder part 30 and the holding portion 82 are spaced apart from each other in the width direction and disposed at an substantially equal distance from the first support protrusion 28, that is, from the biasing member 16.

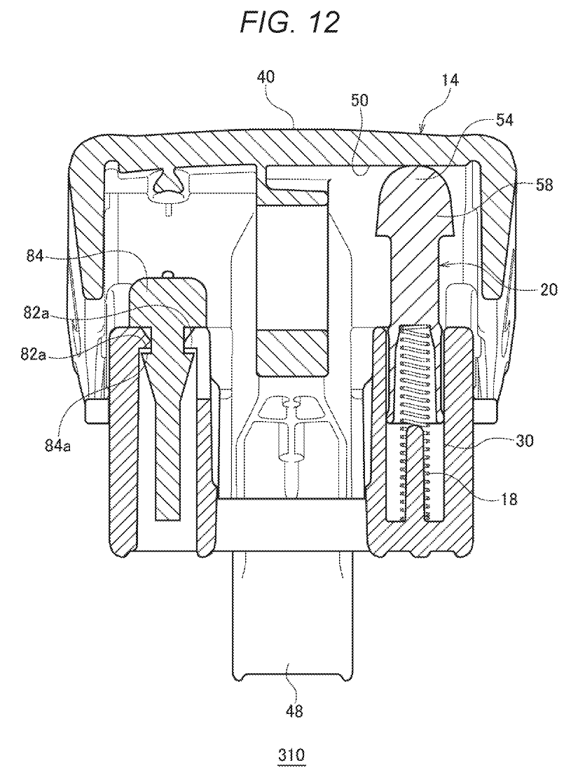

FIG. 12 is a cross-sectional view of the handle device 310 according to the third modification. FIG. 12 shows a cross-section of the fixing member 312 in FIG. 11 taken along the line C-C. The handle device 310 includes not only the piston 20 but also a cushion member 84.

The holding portion 82 is formed in a cylindrical shape and can receive a portion of the cushion member 84 inserted therein. The holding portion 82 includes a plurality of claw parts 82a.

The cushion member 84 includes a protrusion 84a that protrudes radially outward at an intermediate position in the axial direction. The cushion member 84 has a shape bulging at one end and protrudes outside the holding portion 82. The claw parts 82a are engaged with the protrusion 84a to hold the cushion member 84. As a result, the movement of the cushion member 84 in the axial direction is restricted.

The cushion member 84 can be provided at a lower cost than the spring 18 and the piston 20. Meanwhile, the spring 18 and the piston 20 can reduce the impact noise when the handle 14 is closed more efficiently than the cushion member 84. The handle device 310 may be equipped with either an air damper configuration of the spring 18 and the piston 20, or the cushion member 84. As a result, the spring 18 and the piston 20 or the cushion member 84 can be selected depending on applications.

According to the present disclosure, it is possible to provide a handle device capable of effectively reducing an impact noise generated when the handle is closed.

The present disclosure is not limited to each of the embodiments described above, and various modifications such as design changes can be made to each embodiment based on the knowledge of a person skilled in the art, and the embodiment with such modifications may also be included in the scope of the present disclosure.

What is claimed is:

1. A handle device comprising:
a fixing member including a cylinder part having one end open and another end at a bottom portion;
a handle rotatably provided on the fixing member and configured to become an open state or a closed state by rotation;
a biasing member configured to bias the handle in a closing direction; and
a piston inserted into the cylinder part so as to be advanceable and retractable, wherein
the piston includes a sliding part provided on an outer peripheral surface thereof, and
the piston is pushed and retracts toward the bottom portion when the handle is rotated in the closing direction, causing the sliding part to be slid along an inner peripheral surface of the cylinder part in response to the retraction, thereby providing resistance against a closing operation of the handle.

2. The handle device according to claim 1, wherein
the handle includes
a design surface, and
a back surface supporting the piston on a back side of the design surface, and
a central axial direction of the cylinder part intersects with the design surface.

3. The handle device according to claim 1, wherein
the sliding part is formed in an annular shape and configured to come with contact with and seal against the inner peripheral surface of the cylinder part, and
the cylinder part or the piston includes an orifice part communicating between inside and outside of the cylinder part.

4. The handle device according to claim 1, further comprising a spring accommodated in the cylinder part, with one end in contact with the bottom portion and another end in contact with the piston to bias the piston in an advancing direction out of the cylinder part.

5. The handle device according to claim 4, wherein
the piston includes an extension part which is formed in a cylindrical shape and which is open toward the bottom portion,
the spring is positioned inside the extension part, and
the sliding part is formed on an outer peripheral surface of the extension part, and is positioned on an opening side of the extension part.

6. The handle device according to claim 1, wherein
the piston has a rib formed to protrude from an outer peripheral surface of the piston, and
the rib is formed at an intermediate portion of the piston away from the sliding part.

7. The handle device according to claim 1, wherein
the piston includes a cushion part formed on one end side thereof,
the cushion part includes a step portion that protrudes outward in a radial direction, and
when the piston is pushed by the handle and retracts, the step portion comes into contact with an edge of an opening of the cylinder part, stopping the retraction and stopping the closing operation of the handle.

8. The handle device according to claim 1, wherein
the piston has a connection part which is formed on one end side thereof and which is always connected to the handle, and
the handle includes a fitting part which is fitted to the connection part.

9. The handle device according to claim 1, further comprising a locking member movable to a locked position and to an unlocked position, wherein
the handle is configured to move the locking member to the locked position or the unlocked position by a rotating operation.
